(19) United States
(12) Patent Application Publication
(10) Pub. No.: US 2011/0188390 A1
(43) Pub. Date: Aug. 4, 2011

(54) COMMUNICATION TERMINAL AND METHOD THEREOF

(75) Inventors: Yungeun KWAG, Seongnam-si (KR); Eun Jung SONG, Seongnam-si (KR)

(73) Assignee: PANTECH CO., LTD., Seoul (KR)

(21) Appl. No.: 13/006,706

(22) Filed: Jan. 14, 2011

(30) Foreign Application Priority Data
Jan. 29, 2010 (KR) 10-2010-0008827

(51) Int. Cl. H04L 12/26

(52) U.S. Cl. 370/252

(57) ABSTRACT

Disclosed herein are a communication terminal and a method for determining a packet retransmission time in the hand-off thereof. If a hand-off between heterogeneous communication networks with different speeds is generated, a packet retransmission time after the hand-off is determined corresponding to features of a current communication network so that an error packet can be retransmitted at a speed suitable for the corresponding handed-off communication network without waste of communication resources.

### CROSS-REFERENCE TO RELATED APPLICATION

This application claims priority from and the benefit under 35 U.S.C. §119(a) of Korean Patent Application No. 10-2010-0008827, filed on Jan. 29, 2010, which is hereby incorporated by reference for all purposes as if fully set forth herein.

### BACKGROUND

1. Field

Disclosed herein are a communication terminal and a method for determining a packet retransmission time in a hand-off thereof.

2. Discussion of the Background

In general, in a communication terminal that performs mobile communications, a packet is transmitted using a transmission control protocol (TCP). If a response for the packet is transmission is not received after the packet is transmitted, the packet is retransmitted.

In this case, a transmission path of the packet is determined by an internet protocol (IP), which is a lower level of the TCP, and hence, the TCP does not determine or decide how much time is taken until the packet is transmitted to a destination or how much time is taken until a corresponding response is received. Therefore, the communication terminal determines after how much time, from a time when the packet was transmitted, the packet is retransmitted.

The concepts “round trip time (RTT)” and “retransmission time out (RTO)” are used so as to determine such a retransmission time. After a packet is transmitted, an RTT value corresponding to the time taken until a response for the packet transmission is received is measured and stored. If the packet is retransmitted due to no response for the packet transmission after the packet was transmitted, a packet retransmission time is determined by calculating an RTO using the stored RTT value.

Meanwhile, if a communication terminal that performs mobile communications retransmits a packet in a fourth-generation high-speed network, such as long term evolution (LTE), a relatively short RTT is measured. If the communication terminal retransmits the packet in a low-speed network, such as a second- or third-generation network, a relatively long RTT is measured.

However, conventionally, if a communication terminal available for the high-speed and low-speed networks is handed off from the fourth-generation high-speed network to the second- or third-generation low-speed network, a packet retransmission process is unnecessarily performed quickly due to the packet retransmission process performed using the short RTT of the high-speed network, and therefore, communication resources are wasted.

If the communication terminal available for the high-speed and low-speed networks is handed off is handed off from the second- or third-generation low-speed network to the fourth-generation high-speed network, a packet retransmission process is performed using the relatively long RTT of the low-speed network. Therefore, an error packet is not rapidly corrected to be suitable for the corresponding high-speed network, and the time for correcting the error packet is delayed.

### SUMMARY

Exemplary embodiments of the present invention provide a communication terminal and a method for determining a packet retransmission time in the hand-off thereof, in which when a hand-off between heterogeneous communication networks with different transmission speeds is generated, the packet retransmission time after the hand-off is determined corresponding to features of a current communication network so that an error packet can be retransmitted at a speed suitable for the corresponding handed-off communication network without waste of communication resources, thereby increasing efficiency in communications.

Exemplary embodiments of the present invention provide that, if a hand-off between heterogeneous communication networks with different transmission speeds is generated, the packet retransmission time after the hand-off is determined corresponding to features of a current communication network, so that an error packet can be retransmitted at a speed suitable for the corresponding handed-off communication network without waste of communication resources, thereby increasing efficiency in communications.

Additional features of the invention will be set forth in the description which follows, and in part will be apparent from the description, or may be learned by practice of the is invention.

An exemplary embodiment provides a communication terminal, including: a communication unit to transmit/receive a hand-off related signal in a hand-off between heterogeneous communication networks; and a control unit to calculate a round trip time (RTT) of a handed-off communication network according to an RTT measured in a communication network before the hand-off and a baud rate level changed due to the hand-off and to determine a retransmission time out (RTO) calculated according to the calculated RTT as a packet retransmission time if the hand-off between the heterogeneous communication networks is detected through the communication unit.

An exemplary embodiment provides a method for determining a packet retransmission time in a hand-off of a communication terminal, the method including: detecting a hand-off between heterogeneous communication networks; calculating an RTT of a handed-off communication network according to an RTT measured in a communication network before the hand-off and a baud rate level changed due to the hand-off; and determining a retransmission time out (RTO) calculated according to the corresponding RTT as the packet retransmission time.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, is illustrate embodiments of the invention, and together with the description serve to explain the principles of the invention.

FIG. 1 is a block diagram of a communication terminal according to an exemplary embodiment.

FIGS. 2 and 3 are flowcharts illustrating methods according to an exemplary embodiment.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough, and will fully convey the scope of this disclosure to those skilled in the art. In the description, details of well-known features and techniques may be omitted to avoid unnecessarily obscuring the presented exemplary embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. is does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

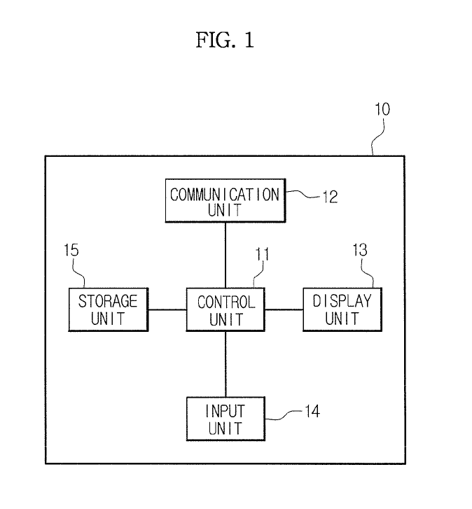

FIG. 1 is a block diagram of a communication terminal according to an exemplary embodiment. Referring to FIG. 1, the communication terminal 10 includes a control unit 11, a communication unit 12, a display unit 13, an input unit 14, and a storage unit 15. The communication unit 12 performs wireless communications under the control of the control unit 11. The communication unit 12 may perform wireless communications with respect to heterogeneous communication networks. For example, the communication unit 12 may perform wireless communications with respect to heterogeneous communication units including 2G CDMA, 2G GPRS, 2G 1X, 2G EGPRS, 3G WCDMA, 4G LTE, 4G LTE Advanced, WIFI, and the like. The communication unit 12 transfers a hand-off related signal transmitted/received in a is hand-off between the heterogeneous communication networks to the control unit 11 so as to allow the control unit 11 to detect the occurrence of the hand-off between the heterogeneous communication networks.

The display unit 13 displays information of the communication terminal 10, including information generated in communications, under the control of the control unit 11. The input unit 14 may include one key or a plurality of keys through which key input data inputted based on a user's key operations is applied to the control unit 11.

The storage unit 15 stores information, programs, and data for the driving of the communication terminal 10. The storage unit 15 stores information, programs, and data for calculating RTT and RTO in the hand-off between the heterogeneous communication networks, and provides the stored information, programs, and data to the control unit 11. The control unit 11 controls the driving of the communication and determines a packet retransmission time by reflecting a feature of a corresponding handed-off communication network if the hand-off between the heterogeneous communication networks with different communication speeds is detected through the communication unit 12. The control unit 11 determines the RTT of the corresponding handed-off communication network by reflecting the feature of the corresponding handed-off communication network and determines a packet retransmission time after the corresponding hand-off by applying the corresponding determined RTT and calculating the RTO of the corresponding handed-off communication network.

The heterogeneous communication networks have different baud rates that respectively correspond to transmission speeds supported in the corresponding networks. The control unit 11 can reflect the baud rate changed due to the hand-off between the heterogeneous communication networks as a feature of the corresponding handed-off communication network. If the RTT of the corresponding handed-off communication network is determined by reflecting the feature of the corresponding handed-off communication network, the control unit 11 may reflect the baud rate changed due to the hand-off as the feature of the corresponding handed-off communication network. If the RTT of the corresponding handed-off communication network is determined by reflecting the changed baud rate as the feature of the corresponding handed-off communication network, the control unit 11 may determine a baud rate change constant (Γ) by applying the corresponding changed baud rate and may calculate an RTT used in the corresponding handed-off communication network by applying the RTT measured in a previous communication network and the corresponding baud rate change constant (Γ).

The control unit 11 uses a baud rate level stored in the storage unit 15 so as to reflect the baud rate changed in the calculation of the RTT. The control unit 11 identifies from which communication network to which communication network the hand-off is performed based on the hand-off related signal received when the hand-off between the heterogeneous communication networks is detected through the communication unit 12, and the control unit 11 determines the baud rate change constant (Γ) by obtaining the baud rate level corresponding to the corresponding identified communication network from the storage unit 15. The baud rate level stored in the storage unit 15 is predetermined corresponding to each of the heterogeneous communication networks as shown in Table 1.

TABLE 1

| Kind of | |
|---|---|
| Communication | |
| Network | Baud rate Level |
| 2G CDMA | 0.25 |
| 2G GPRS | 0.25 |
| 2G 1X | 0.5 |
| 2G GPRS | 0.5 |
| 3G WCDMA | 0.75 |
| 4G LTE | 1 |
| WIFI | 1 |

If the baud rate change constant (Γ) is determined by applying the changed baud rate level, the control unit 11 determines the baud rate change constant (Γ) by calculating the baud rate change constant (Γ) as shown in Equation 1.

Γ=1+(baud rate level before hand-off−baud rate level after hand-off) [Equation 1]

For example, if the communication terminal 10 is handed off from the 2G GPRS network to the 3G WCDMA network, the control unit 11 applies 0.25 for the 2G GPRS network as the baud rate level before the hand-off and 0.75 for the 3G WCDMA network to the baud rate level after hand-off to Equation 1 with reference to the baud rate levels, such as Table 1, stored in the storage unit 15. The control unit 11 determines the baud rate change constant (Γ) as 0.5 from Equation 1.

After the baud rate constant (Γ) is determined, the control unit 11 calculates the RTT used in the corresponding handed-off communication network by applying the RTT measured in the previous communication network and the corresponding baud rate change constant (Γ). The RTT used in the corresponding handed-off communication network is calculated as shown in Equation 2.

RTT=(mRTT)(Γ) [Equation 2]

Here, RTT denotes an RTT used in a handed-off communication network, mRTT is denotes an RTT measured in a previous communication network, and Γ denotes a baud rate change constant.

The control unit 11 calculates an RTT used in a handed-off communication network and then calculates an RTO by applying the corresponding calculated RTT, so that the corresponding RTO is determined as a packet retransmission time. The corresponding RTO may be calculated as shown in Equation 3.

RTO=SRTT+4D [Equation 3]

Here, SRTT denotes a weighted average of each RTT as a smoothed RTT, and D denotes a weight that indicates how much a recent RTT is deviated from the average of previous RTTs.

The SRTT described in Equation 3 may be calculated as shown in Equation 4.

SRTT=((1−x)smSRTT))+(x+RTT) [Equation 4]

Here, mSRTT denotes an average of previous RTTs, x denotes a weight, and RTT denotes an RTT calculated as shown in Equation 2 in the hand-off between heterogeneous communication networks as an RTT measured recently.

If the control unit 11 of the communication terminal 10 determines the RTT of the corresponding handed-off communication network by reflecting the feature of the corresponding handed-off communication network, a baud rate changed, and a wireless receiving sensitivity, which are changed due to the hand-off, may be reflected as features of the corresponding handed-off communication network.

If the RTT of the corresponding handed-off communication network is determined by reflecting the changed baud rate and the changed wireless receiving sensitivity as the features of the corresponding handed-off communication network, the control unit 11 may determine a baud rate change constant (Γ) by applying the corresponding changed baud rate and may determine a receiving sensitivity constant (Δ) by applying the corresponding changed wireless receiving sensitivity. Then, the control unit 11 may calculate an RTT used in the corresponding handed-off network by applying the RTT measured in the previous communication network, the corresponding baud rate change constant (Γ), and the receiving sensitivity constant (Δ).

The control unit 11 uses baud rates, such as in Table 1, stored in the storage unit 15 so as to reflect the baud rate changed in the calculation of the RTT. If the baud rate change constant (Γ) is determined by applying the corresponding changed baud rate level, the control unit 11 determines the baud rate change constant (Γ) as shown in Equation 1.

The control unit 11 uses a receiving sensitivity constant (Δ) set corresponding to the receiving sensitivity stored in the storage unit 15 so as to reflect the wireless receiving sensitivity changed in the calculation of the RTT. The receiving sensitivity constant (Δ) is predetermined corresponding to each wireless receiving sensitivity as shown in Table 2.

TABLE 2

| Receiving Sensitivity | Receiving Sensitivity Constant (Δ) |
|---|---|
| −60 dB or more | 1.1 |
| −60 dB~−80 dB | 1 |
| −80 dB or less | 0.9 |

The control unit 11 determines a receiving sensitivity constant (Δ) by selecting a receiving sensitivity constant (Δ) corresponding to the wireless receiving sensitivity of the corresponding handed-off communication network, measured by the signal received through the communication unit 12 in the detection of the hand-off between the heterogeneous communication networks, from data, such as in Table 2, stored in the storage unit 15. For example, if the measured receiving sensitivity is −60 dB or higher in the detection of the hand-off between the heterogeneous communication networks, the control unit 11 determines the receiving sensitivity constant (Δ) as 1.1. If the measured receiving sensitivity is −60 dB to −80 dB in the detection of the hand-off between the heterogeneous communication networks, the control unit 11 determines the receiving sensitivity constant (Δ) as 1. If the measured receiving sensitivity is −80 dB or lower in the detection of the hand-off between the heterogeneous communication networks, the control unit 11 determines the receiving sensitivity constant (Δ) as 0.9.

After the baud rate change constant (Γ) and the receiving sensitivity constant (Δ) are determined, the control unit 11 calculates an RTT used in the corresponding handed-off communication network by applying the RTT measured in the previous communication network, the baud rate change constant (Γ), and the receiving sensitivity constant (Δ). The RTT used in the corresponding handed-off communication network is calculated as shown in Equation 5

RTT=(mRTT)(Γ)(Δ) [Equation 5]

Here, RTT denotes an RTT used in a handed-off communication network, mRTT denotes an RTT measured in a previous communication network, Γ denotes a baud rate change constant, and Δ denotes a receiving sensitivity constant.

The control unit 11 calculates an RTT used in the corresponding handed-off communication network and then calculates an RTO by applying the corresponding calculated RTT, so that the RTO is determined as a packet retransmission time. The corresponding RTO may be calculated as shown in Equation 3.

The SRTT described in Equation 3 may be calculated as shown in Equation 4.

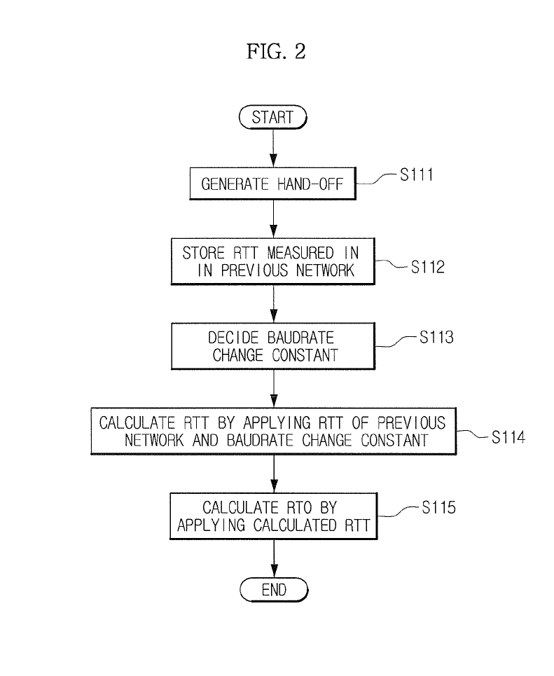

If the communication terminal 10 determines an RTT of a corresponding handed-off communication network by reflecting a baud rate changed in the hand-off between heterogeneous communication networks with different transmission speeds, a method for determining a packet retransmission time is performed as shown in FIG. 2. FIG. 2 is a flowchart illustrating a method according to an exemplary embodiment.

First, if a hand-off between heterogeneous communication networks is generated, the control unit 11 of the communication terminal 10 detects the hand-off between the heterogeneous communication networks through the communication unit 12 in operation S111. The hand-off between the heterogeneous communication networks may be generated, for example, if the communication terminal 10 is moved, if a connection to current communication network is lost, or according to a signal strength of the heterogeneous communication networks.

In this case, the control unit 11 stores an RTT measured in a previous communication network in the storage unit 15 in operation S112. The previous communication network may be the communication network from which the hand-off is performed. The control unit 11 determines a baud rate change constant (Γ) by identifying from which communication network to which communication network the hand-off is performed based on a hand-off related signal received through the communication unit 12 and obtaining a baud rate level corresponding to the identified communication network from Table 1 of the storage unit 15. In operation S113, the control unit 11 determines the baud rate change constant (Γ) by applying a baud rate level before the hand-off and a baud rate level after the hand-off as shown in Equation 1.

The control unit 11 calculates an RTT used in the corresponding handed-off communication network by applying the RTT measured in the previous communication network and the corresponding baud rate change constant (Γ). In operation S114, the control unit calculates the RTT used in the corresponding handed-off communication network as shown in Equation 2.

After the RTT used in the corresponding handed-off communication network is calculated, the control unit 11 calculates an RTO by applying the corresponding calculated RTT so that the corresponding RTO is determined as a packet retransmission time. In operation S115, the control unit 11 calculates the RTO as shown in Equation 3.

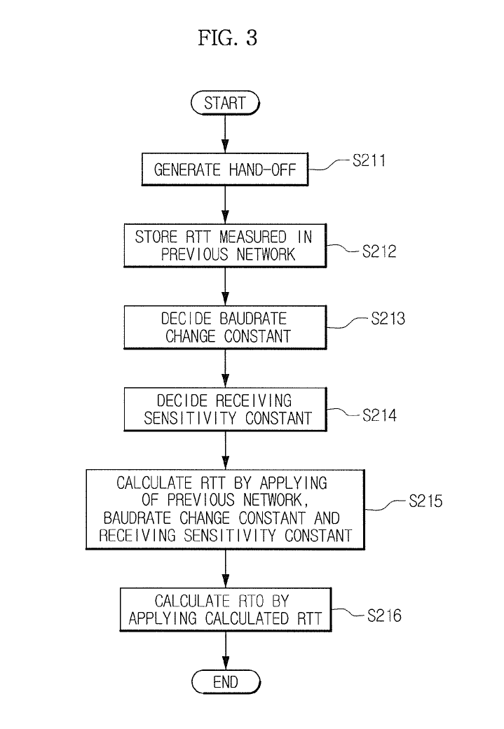

If the communication terminal 10 determines an RTT of a corresponding handed-off communication network by reflecting a baud rate and a wireless receiving sensitivity, which are changed in the hand-off between the heterogeneous communication networks with different transmission speeds, a method for determining a packet retransmission time is performed as shown in FIG. 3. FIG. 3 is a flowchart illustrating a method according to an exemplary embodiment.

First, if a hand-off between heterogeneous communication networks is generated, the control unit 11 of the communication terminal 10 detects the hand-off between the heterogeneous communication networks through the communication unit 12 in operation S211.

The control unit 11 stores an RTT measured in a previous communication network in the storage unit 15 in operation S212. The control unit 11 determines a baud rate change constant (Γ) by identifying from which communication network to which communication network the hand-off is performed based on a hand-off related signal received through the communication unit 12 and obtaining a baud rate level corresponding to the identified is communication network from Table 1 of the storage unit 15. In operation S213, the control unit 11 determines the baud rate change constant (Γ) by applying a baud rate level before the hand-off and a baud rate level after the hand-off as shown in Equation 1.

In operation S214, the control unit 11 determines a receiving sensitivity constant (Δ) by selecting the receiving sensitivity constant (Δ) corresponding to the wireless receiving sensitivity of the corresponding handed-off communication network, measured by the hand-off related signal received through the communication unit 12, from Table 2 of the storage unit 15.

The control unit 11 calculates an RTT used in the corresponding handed-off communication network by applying the RTT measured in the previous communication network, the baud rate change constant (Γ), and the receiving sensitivity constant (Δ). In operation 5215, the control unit 11 calculates the RTT used in the corresponding handed-off communication network as shown in Equation 5.

After the RTT used in the corresponding handed-off communication network is calculated, the control unit 11 calculates an RTO by applying the corresponding calculated RTT so that the corresponding RTO is determined as a packet retransmission time. In operation 5216, the control unit 11 calculates the RTO as shown in Equation 3.

As described above, the communication terminal 10 determines a packet retransmission time by reflecting features of a corresponding handed-off communication network in the hand-off between heterogeneous communication networks with different transmission speeds. The communication terminal 10 determines an RTT of the corresponding handed-off communication network by reflecting a changed baud rate or reflecting a baud rate and a wireless receiving sensitivity, which are changed in the hand-off between the heterogeneous communication networks. The communication terminal 10 calculates an RTO of the corresponding handed-off communication network by applying the corresponding determined RTT, thereby determining the packet retransmission time after the corresponding hand-off.

Accordingly, when a hand-off between heterogeneous communication networks with different transmission speeds is generated, the packet retransmission time after the hand-off is determined corresponding to features of a current communication network so that an error packet can be retransmitted at a speed suitable for the corresponding handed-off communication network without waste of communication resources, thereby increasing efficiency of communications.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A communication terminal, comprising:
a communication unit to transmit/receive a hand-off related signal in a hand-off between heterogeneous communication networks; and
a control unit to calculate a round trip time (RTT) of a handed-off communication network according to an RTT measured in a communication network before the hand-off and a baud rate level changed due to the hand-off and to determine a retransmission time out (RTO) calculated according to the calculated RTT as a packet retransmission time if the hand-off between the heterogeneous communication networks is detected through the communication unit.

2. The communication unit of claim 1, further comprising a storage unit to store baud rate levels of a plurality of heterogeneous communication networks and to provide to the control unit a baud rate level before a hand-off and a baud rate level after the hand-off in the hand-off between heterogeneous communication networks.

3. The communication unit of claim 2, wherein the control unit calculates the RTT of the handed-off communication network according to a baud rate change constant (Γ) obtained according to the changed baud rate level identified from the storage unit as shown in Equation 1:
RTT=(mRTT)(Γ) [Equation 1]
wherein RTT is an RTT of a handed-off communication network, mRTT is an RTT of a communication network before the hand-off, and Γ is a baud rate change constant obtained according to a changed baud rate level, in which Γ=1+(baud rate level before hand-off−baud rate level after hand-off).

4. The communication unit of claim 2, wherein the storage unit stores a receiving sensitivity constant (Δ) corresponding to the wireless receiving sensitivity measured in the hand-off, and provides a receiving sensitivity constant (Δ) corresponding to the receiving sensitivity constant (Δ) measured by the control unit in the hand-off between the heterogeneous communication networks to the control unit.

5. The communication unit of claim 4, wherein the control unit calculates an RTT of the handed-off communication network according to the baud rate change constant (Γ) obtained according to the changed baud rate level identified from the storage unit and the receiving sensitivity constant (Δ) corresponding to the receiving sensitivity constant (Δ) measured by the control unit as shown in FIG. 2:
RTT=(mRTT)(Γ)(Δ) [Equation 2]
wherein RTT is an RTT of a handed-off communication network, mRTT is an RTT of a communication network before the hand-off, Γ is a baud rate change constant obtained by reflecting a changed baud rate level, in which Γ=1+(baud rate level before hand-off−baud rate level after hand-off), and Δ is a receiving sensitivity constant obtained according to a measured wireless receiving sensitivity.

6. The communication unit of claim 1, wherein the control unit calculates the RTT of the handed-off communication network according to a baud rate change constant (Γ) obtained according to the changed baud rate level identified from the storage unit as shown in Equation 3:
RTT=(mRTT)(Γ) [Equation 3]
wherein RTT is an RTT of a handed-off communication network, mRTT is an RTT of a communication network before the hand-off, and Γ is a baud rate change constant obtained according to a changed baud rate level, in which Γ=1+(baud rate level before hand-off−baud rate level after hand-off).

7. The communication unit of claim 1, wherein the control unit calculates the RTT of the handed-off communication network further according to a wireless receiving sensitivity measured in the hand-off.

8. The communication unit of claim 7, wherein the storage unit stores a receiving sensitivity constant (Δ) corresponding to the wireless receiving sensitivity measured in the hand-off, and provides a receiving sensitivity constant (Δ) corresponding to the receiving sensitivity constant (Δ) measured by the control unit in the hand-off between the heterogeneous communication networks to the control unit.

9. The communication unit of claim 8, wherein the control unit calculates an RTT of the handed-off communication network according to the baud rate change constant (Γ) obtained according to the changed baud rate level identified from the storage unit and the receiving sensitivity constant (Δ) corresponding to the receiving sensitivity constant (Δ) measured by the control unit as shown in Equation 4:
RTT=(mRTT)(Γ)(Δ) [Equation 4]
wherein RTT is an RTT of a handed-off communication network, mRTT is an RTT of a communication network before the hand-off, Γ is a baud rate change constant obtained according to a changed baud rate level, in which Γ=1+(baud rate level before hand-off−baud rate level after hand-off), and Δ is a receiving sensitivity constant obtained according to a measured wireless receiving sensitivity.

10. The communication unit of claim 1, wherein the RTO is calculated according to the following Equation 5:
RTO=SRTT+4D [Equation 5]
wherein SRTT is a weighted average of each RTT as a smoothed RTT, and D is a weight that indicates how much a recent RTT is deviated from the average of previous RTTs.

11. A method for determining a packet retransmission time in a hand-off of a communication terminal, the method comprising:
detecting a hand-off between heterogeneous communication networks;
calculating an RTT of a handed-off communication network according to an RTT measured in a communication network before the hand-off and a baud rate level changed due to the hand-off; and
determining a retransmission time out (RTO) calculated according to the corresponding RTT as the packet retransmission time.

12. The method of claim 11, wherein the calculating of the RTT of the handed-off communication network comprises:
storing the RTT measured in the communication network before the hand-off;
detecting a baud rate changed in the hand-off and calculating a baud rate change constant (Γ) obtained according to the calculated baud rate; and
calculating the RTT of the handed-off communication network according to the RTT measured in the communication network before the hand-off and the baud rate change constant (Γ).

13. The method of claim 12, wherein the baud rate change constant (Γ) is calculated as shown in Equation 6:
Γ=1+(baud rate level before hand-off−baud rate level after hand-off). [Equation 6]

14. The method of claim 12, wherein the RTT of the handed-off communication network is calculated as shown in Equation 7:
RTT=(mRTT)(Γ) [Equation 7]
wherein RTT is an RTT of a handed-off communication network, mRTT is an RTT measured in a communication network before the hand-off, and Γ is a baud rate change constant.

15. The method of claim 11, wherein the calculating the RTT of the handed-off communication network comprises calculating the RTT of the handed-off communication network further according to a wireless receiving sensitivity measured in the hand-off.

16. The method of claim 15, wherein the calculating of the RTT of the handed-off communication network further comprises:
storing the RTT measured in the communication network before the hand-off;
detecting a baud rate changed in the hand-off and calculating a baud rate change constant (Γ) obtained according to the calculated baud rate;
determining a receiving sensitivity constant (Δ) according to the wireless receiving sensitivity measured in the hand-off; and
calculating the RTT of the handed-off communication network according to the RTT measured in the communication network before the hand-off, the baud rate change constant (Γ), and the receiving sensitivity constant (Δ).

17. The method of claim 16, wherein the baud rate change constant (Γ) is calculated as shown in Equation 8:
Γ=1+(baud rate level before hand-off−baud rate level after hand-off). [Equation 8]

18. The method of claim 11, wherein the RTT of the handed-off communication network is calculated as shown in Equation 9:
RTT=(mRTT)(Γ) [Equation 9]
wherein RTT is an RTT of a handed-off communication network, mRTT is an RTT measured in a communication network before the hand-off, and Γ is a baud rate change constant.

19. The method of claim 16, wherein the receiving sensitivity constant (Δ) is determined as a constant corresponding to the wireless receiving sensitivity measured in the hand-off.

20. The method of claim 16, wherein the RTT of the handed-off communication network is calculated as shown in Equation 10:
RTT=(mRTT)(Γ)(Δ) [Equation 10]
wherein RTT is an RTT of a handed-off communication network, mRTT is an RTT measured in a communication network before the hand-off, Γ is a baud rate change constant, and Δ denotes a receiving sensitivity constant.
